(19) United States
(12) Patent Application Publication
(10) Pub. No.: US 2004/0156770 A1
(43) Pub. Date: Aug. 12, 2004

(54) Process for catalytic, selective oxidation of carbon monoxide in gaseous mixtures containing excess hydrogen, a catalyst and a process for its preparation

(76) Inventors: Stanko Hocevar, Liubliana (SI); Jurka Batista, Liubliana (SI); Haralambos Matralis, Patras (GR); Theophilos Ioannides, Patras (GR); George Avgourofoulos, Athens (GR)

Correspondence Address: HAHN LOESER & PARKS, LLP, TWIN OAKS ESTATE, 1225 W. MARKET STREET, AKRON, OH, 44313, US

(21) Appl. No.: 10/204,088

(22) PCT Filed: Feb. 9, 2001
(86) PCT No.: PCT/SI01/00005

(51) Int. Cl. B01D 53/62

(52) U.S. Cl. 423/247

(57) ABSTRACT

The invention refers to a process for catalytic, selective oxidation of carbon monoxide in gaseous mixtures containing excess hydrogen with stoichiometric quantity of oxygen at the temperature between 298 K and 573 K, pressure between 1 and 10 bar and at the ratio of oxygen and carbon monoxide partial pressures (λ=2p₀₂/p_{CO}) between 1.0 and 2.5, in a one-step flow reactor at contact time (W/F) between 0.03 and 0.40 g.s.cm⁻³, or at the flow rate of the gaseous mixture (F) between 0.083 cm³/s and 1.67 cm³/s in the presence of 0.010 to 0.100 g of the catalyst, namely the complex oxide of the formula CuₓCe₁₋ₓxO_{2-y}, where x is between 0.01 and 0.30 while y is equal or greater than x. This invention refers also to a process for the catalyst preparation and to the catalyst prepared by this process. This invention is useful in the field of fuel technology for low temperature fuel cells.

### TECHNICAL FIELD OF THE INVENTION

This invention refers to a process for catalytic, selective oxidation of carbon monoxide in gaseous mixtures containing excess hydrogen that runs at low temperature, to a process for the preparation of the catalyst used in catalytic oxidation and to the catalyst, i.e. complex oxide, prepared by this process.

### PRIOR ART

Hydrogen is obtained by one of the possible processes from fossil fuels or from renewable sources of energy, and is used as a fuel for low temperature fuel cells.

Hydrogen can be produced as a part of the synthesis gas (xH₂+yCO) by gasification of coal, by partial oxidation, steam reforming and autothermal reforming of lower hydrocarbons (e.g. methane) or lower alcohols (e.g. methanol). These processes yield beside hydrogen also carbon monoxide, carbon dioxide and water. The concentration of carbon monoxide in so produced hydrogen is within the range of 1 to 50 vol. % [Ullmann's Encyclopedia of Industrial Chemistry, VCH, Weinheim, 1989, Vol. A13, 312-333].

Hydrogen is used in many chemical industrial processes as one of the reactants in the reactions catalyzed by noble metals (Pt, Pd). The carbon monoxide blocks action of the catalyst due to the strong chemisorption, especially at low reaction temperatures (below 423 K). Therefore, the concentration of carbon monoxide in the refining processes (hydrocracking, platforming, selectoforming) has to be lower than 0.1 vol. %; in the processes of hydrogenation of fats and oils it has to be lower than 10 ppm, and in the process of ammonia synthesis it has to be even lower than 1 ppm [Ullmann's Encyclopedia of Industrial Chemistry, VCH, Weinheim, 1989, Vol. A13, 376]. When the hydrogen is used as a fuel for the low temperature fuel cells, the concentration of carbon monoxide therein is also preferably as low as possible, but in any case lower than 100 ppm.

Selective membranes technically perform the carbon monoxide removal from gaseous streams rich in hydrogen by the catalytic water gas reaction, and the shift reaction (Water Gas Shift Reaction, WGSR), and by the catalytic methanation reaction or by the catalytic, selective oxidation of carbon monoxide [Ullmann's Encyclopedia of Industrial Chemistry, VCH, Weinheim, 1989, Vol. A13, 376-378]. The catalyst is usually a finely dispersed noble metal (Pt, Ru, Pd, Au) on oxide support (γ-Al₂O₃, ZrO₂, TiO₂, zeolite, etc.) in the form of pellets, beads, cylinders or hollow cylinders that are filled into the reactor tube.

The selective oxidation of carbon monoxide runs as the following reaction:

CO+0.5O₂→CO₂

In dependence of the working temperature the reaction is normally performed with the following catalysts [EP 0 650 922 A1 and EP 0 650 923 A1]

363-393 K: Pt/γ-Al₂O₃, Ru/γ-Al₂O₃

especially: Pt (5 wt. %)/γ-Al₂O₃ in the form of a layer on metal supports, Ru (0,44 wt. %)/γ-Al₂O₃ in the form of pellets

413-433 K: Pt/γ-Al₂O₃

especially: Pt (0,3 wt. %)/γ-Al₂O₃ in the form of beads

473-503 K: Pt/zeolite

especially: Pt (1 wt. %)/NaY in the form of cylinders (extrudates).

The working temperature of Proton Exchange Membrane Fuel Cells (PEMFC) is between 353 and 373 K. The reaction temperature for hydrogen production by autothermal reforming of methanol is between 523 and 573 K. The produced gaseous mixture contains ˜66 vol. % H₂, ˜44 vol. % CO₂, ˜10 vol. % H₂O, ˜1 vol. % CH₃OH and ˜1 vol. % CO. Because of the effective use of waste heat the disposal of CO by means of selective oxidation of carbon monoxide is economically feasible to perform either at the reformer working temperature or at the fuel cell working temperature. However, the reformer working temperature is already so high that the selectivity of the carbon monoxide oxidation is impaired owing to a parallel reaction of hydrogen oxidation running at these high temperatures. The fuel cell working temperature is below the lower limiting values for the effective performance of reactors with existing catalysts for the selective carbon monoxide oxidation in gaseous mixtures containing excess hydrogen.

### DESCRIPTION OF THE INVENTION

The first object of this invention is a novel process for the catalytic, selective oxidation of carbon monoxide in gaseous mixtures containing excess hydrogen in which gaseous mixtures, comprising between 0.1 and 10 vol. % CO, between 10 and 30 vol. % CO₂, between 40 and 70 vol. % H₂, between 0 and 5 vol. % H₂O, and under 1 vol. % of unconverted fuel, are oxidised with a stoichiometric amount of oxygen at temperatures between 298 and 573 K, pressures between 1 and 10 bar and at the ratio of the partial pressures of oxygen and carbon monoxide (λ=2p₀₂/p_{co}) between 1.0 and 2.5 in a one-step flow reactor at contact times (W/F) between 0.03 and 0.40 g·s·cm⁻³ or at the flow rate of the gaseous mixture (F) between 0.083 and 1.67 cm³/s in the presence of 0.010 to 0.100 g of a catalyst (W):

a complex oxide of the formula CuₓCe₁₋ₓO_{2-y}, where x is between 0.01 and 0.30 while y is equal or greater than x, and the oxide phases present in it can be qualitatively determined by powder X-ray diffraction as having the following unit cell parameters:

CeO₂ (cerianite): cubic Fm3m; a=0,541134 nm; st.dev.=±0,00012;

Cu₂O (cuprite): cubic Pn3m; a=0,42696 nm;

CuO (tenorite): monoclinic C₂/c; a=0,4685 nm;

b=0,3423 nm;

c=0,5132 nm;

β=99,52°

The various embodiments of the process are: the catalytic oxidation of the carbon monoxide, the catalytic oxidation of the carbon monoxide in the presence of excess CO₂, the catalytic selective oxidation of carbon monoxide in the gaseous mixture containing excess hydrogen, and the catalytic selective oxidation of carbon monoxide in the gaseous mixture containing excess hydrogen and excess CO₂.

The second object of this invention is a novel process for the preparation of the above-mentioned catalyst in which:

a) copper and cerium ions are co-precipitated from an aqueous solution with a concentration of 0.03 to 0.9 F of a mixture of dissolved and well dissociated copper and cerium salts, in which the volume ratio of the aqueous solutions of copper and cerium salts having an equal formality is between 1:99 and 25:75, by the addition of a strong alkaline precipitant in an acidic medium, at a volume ratio of the mixture consisting of the solutions of the Cu and Ce ions, and the precipitant solution between 10:1 and 5:1, while stirring at 60 to 4000 rpm, within the time interval of 30 to 90 minutes;

b) the obtained co-precipitation product is filtered, the filtered precipitate is washed with hot demineralized water and dried to a powder;

c) optionally, by the addition of usual binders to the obtained powder the catalyst is shaped in the usual manner;

d) the obtained powdery or shaped catalysts are heat-treated at “shallow bed” conditions during 15 to 300 minutes at a temperature between 773 and 1133 K.

The third object of this invention is the catalyst to be used in the process of catalytic, selective oxidation of carbon monoxide in gaseous mixtures containing excess hydrogen, which is obtained by the above process.

The process for the preparation of the catalytic complex oxide of the formula CuₓCe_{1-X}O_{2-y}, where x is between 0.01 and 0.30 while y is equal or greater than x, is achieved by:

filtering the precipitate obtained by the co-precipitation of the mixture of the aqueous solutions of the Cu and Ce salts;

washing the filtered precipitate with demineralized water;

drying the washed precipitate to obtain a powder-form material;

adding a suitable organic binder to the dried powder-form material and shaping the catalyst mixture into suitable shaped pieces like pellets, beads, cylinders, hollow cylinders;

heat-treating the shaped catalyst at a suitable temperature for a correspondingly long time in an air-flow in order to obtain a suitable catalyst.

Suitable cerium salts for preparing the mentioned catalyst include all water soluble and well dissociated cerium salts as for instance cerium (III) nitrate, cerium (III) chloride, cerium (III) sulphate, etc.

Suitable copper salts for preparing the mentioned catalyst include all water soluble and well dissociated copper salts as for instance copper (II) nitrate, copper (II) chloride, copper (II) sulphate, etc.

Suitable alkaline precipitants for preparing the mentioned catalyst include all water soluble, hydrolysable salts of strong bases and weak acids as for instance sodium carbonate and ammonium oxalate.

In the following is described in detail the preparation of the catalyst by means of co-precipitation for the selective oxidation of carbon monoxide in gaseous mixtures with excess hydrogen and/or carbon dioxide.

The preferred embodiment of such a catalyst is prepared in the shape of cylinders by extrusion of the calcined precipitate powder, which is obtained from the solution comprising cerium and copper ions by co-precipitation with the addition of a solution of an alkaline precipitant. The calcined precipitate powder is not the mechanical mixture of these metals but is rather a complex oxide compound of highly dispersed copper (I) and copper (II) oxides and of cerium oxide. The dimensions of the primary cerium oxide particles are between a few nanometers and several ten nanometers, while the two phases are in good mutual contact. The qualitative ratio of the two metal ions in the catalyst is equal to their ratio in the starting solutions.

The manufacture of the catalyst is characterized in that it is initiated with the preparation of a mixture of aqueous solutions of cerium and copper salts.

In the preparation of solutions with a mixture of cerium and copper ions it is preferred to employ cerium (III) nitrate and copper (II) nitrate.

In the preparation of co-precipitates the preferred concentration range of the cerium and copper salts in the aqueous solutions is between 0.03 and 0.9 F. In mixing aqueous solutions of copper and cerium salts for obtaining precipitates it is preferred to employ equimolar solutions with the volume ratio of these solutions between 1:99 and 25:75. If the concentrations of the aqueous solutions of the cerium or copper ions are below the mentioned lower limiting value, the yield of the precipitate is too low. If, however the concentrations are higher than the mentioned upper limiting value, the suspension of the precipitate becomes too dense for effective mixing that is the guarantee for the homogeneity and the high dispersion of oxide phases in the precipitate. When the volume ratio of the aqueous solutions of the copper and cerium salts is out of the mentioned range, the catalytic activity of the resulting precipitates is too low.

The preparation of the catalyst is further characterized in co-precipitation of copper and cerium ions with a suitable alkaline precipitant in a slightly acidic medium.

In co-precipitation of cerium and copper ions from aqueous solutions it is preferred to employ water-soluble salts of a strong base and a weak acid, as for instance sodium carbonate or ammonium oxalate.

In co-precipitation of cerium and copper ions from solutions it is preferred to employ an aqueous solution of sodium carbonate.

It is preferred to employ such a concentration range of the solutions of these salts, that the volume ratio between the mixture of cerium and copper ions solutions and the solution of the precipitant is preserved at 5:1, that the co-precipitation proceeds in an acidic medium (pH<6.0) and that the co-precipitation is quantitative.

The preparation of the catalyst is further characterized in that the co-precipitation proceeds while the precipitant is added under continuous stirring of the solution or the forming suspension, and the continuous control of the pH of the solution or the suspension.

The preferred dose of the precipitant is within the range of 0.1 and 3.0 mL/min, when the volume of the solution of the cerium and copper salts is 100 mL.

The preferred stirring speed in employing a magnetic stirrer or propeller stirrer is between 60 and 4000 rpm.

The preparation of the catalyst is further characterized in that after the completed co-precipitation the obtained suspension is homogenized by further mixing for 30 to 60 minutes.

The resulting suspension is preferably homogenized for further 60 minutes under stirring of an equal intensity as during the co-precipitation process.

The preparation of the catalyst is further characterized in that the resulting precipitate is filtered and washed on the filter With several volumes of boiling demineralized water.

Preferably the catalyst is filtered by employing a suction filter through a “Blue ribbon” filter, and, washed with a triple volume of boiling demineralized water.

The preparation of the catalyst is further characterized in that the washed and filtered precipitate is dried for 6 to 12 hours at the temperature between 378 K and 398 K.

The catalyst is preferably dried for 12 hours at the temperature of 398 K.

The preparation of the catalyst is further characterized in that the dried precipitate is heat-treated in the form of a “shallow bed” in a flow of dry air for 15 to 180 minutes at the temperature between 773 K and 1133 K.

Preferably the catalyst is heat-treated in the form of a “shallow bed” on a glazed ceramic support in the muffle oven for 60 minutes at 1133 K in an air flow.

The preparation of a catalyst is further characterized in that an organic binder and water are added to the heat-treated catalyst.

Preferred organic binders employed in the manufacture of shaped pieces are camphor, melamine, starch, acetylcellulose, etc.

Camphor is preferably employed as organic binder.

The preparation of the catalyst is further characterized in that the manufactured mixture is homogenized in a suitable kneading-machine, for instance in an extruder.

In kneading the catalyst mass it is preferred to employ a winding kneader.

The preparation of the catalyst is further characterized in that the mechanical forming of the homogenized mixture into shaped pieces having suitable cross-section profile, and length, is performed for instance by extruding the mixture through the nozzle with a suitable cross-section profile, and cutting the pieces to suitable length.

It is preferred to prepare pieces in the shape of honeycomb monolith, cylinders or pellets.

The shaped pieces are preferably prepared by applying a pressure between 100 and 500 Ncm⁻² (1-5 Mpa) on a mixture of the catalyst and the binder in a pelletizer.

It is preferred to press the mixture of the binder and the catalyst in the pelletizer into cylinders having a diameter between 2 and 5 mm and a height of 2 mm.

The preparation of the catalyst is further characterized in that the shaped pieces are dried in an air flow at suitable conditions.

In drying the shaped pieces it is preferred to employ an air-drier set at a temperature under 398 K.

The preparation of the catalyst is further characterized in that the dried shaped pieces are heat-treated under an air flow at such temperature and for so long that the organic binder is burned out completely, and that the shaped pieces attain appropriate mechanical strength against crushing and attrition.

It is preferred to heat-treat the shaped pieces in a flow oven for 60 minutes at 1133 K and in a flow of dry air of 6 Lh⁻¹ per 100 g of shaped pieces.

The process enables to prepare the shaped pieces of the catalyst suitable for a proper type of the chemical reactor.

In the following is described a process for obtaining the CuₓCe₁₋ₓO_{2-y} catalyst in the form of a complex oxide by means of co-precipitation.

In this invention there is indeed described a process for obtaining the catalyst by co-precipitation of cerium and copper ions, but such a catalyst in the form of a complex oxide can be prepared also by using other processes.

The precipitate (co-precipitate) is prepared by dissolving cerium (III) nitrate and copper (II) nitrate in water under vigorous stirring and simultaneous addition of an aqueous solution of sodium carbonate, which results in the formation of a precipitate. The latter is filtered, washed, dried and then heat-treated under the flow of air at the temperature in the range between 773 K and 1133 K. This procedure is carried out practically as described in what follows. Copper and cerium starting compounds, namely cerium (III) nitrate and copper (II) nitrate, are first dissolved in water in such a mutual ratio that will result in the desired mass ratio of CuO and CeO₂ in the final catalyst. In the acidic range of pH this solution has a concentration in the range between 0.03 and 0.9 F, or, recalculated on CuO and CeO₂ in their suitable mutual proportions, between 10 and 50 g of the oxide catalyst per 1 litre of the solution. During the preparation process this solution can have a temperature between 283 K and 373 K. The sodium carbonate solution is then slowly added to the vigorously stirrred solution (60 and 4000 rpm). The concentration of the sodium carbonate solution is such that, after the co-precipitation procedure is finished, the volume ratio of the metal nitrates solution and the sodium carbonate solution is 5:1. The sodium carbonate solution is added at the rate in the range between 0.1 and 3.0 mLmin⁻¹ in the case when the volume of the metal nitrates solution is 100 mL. Co-precipitation occurs in an acidic medium, so that the pH of the solution never exceeds 6.0. The resulting suspension is stirred at the same speed for additional 30 to 60 minutes in order to complete the co-precipitation. The prepared precipitate (co-precipitate) containing cerium and copper, is filtered and thoroughly washed with boiling redistilled water until substantially all the occluded sodium is removed from the precipitate (co-precipitate). The latter is then dried between 6 and 12 hours at a temperature between 378 K and 398 K. The dried precipitate is then heat-treated in a shallow bed under the flow of dry air for 15 to 300 minutes at a temperature between 773 K and 1133 K. The final product is a complex oxide CuₓCe₁₋ₓO_{2-y} representing a catalyst for the selective oxidation of carbon monoxide in the gaseous mixtures with excess hydrogen.

In the following are described and explained the reaction conditions under which operates our proposed catalytic, selective oxidation of carbon monoxide in the gaseous mixtures containing excess hydrogen.

The catalytic, selective oxidation of carbon monoxide (CO) in the gaseous mixtures containing excess hydrogen is carried out under defined reaction conditions in a fixed bed flow reactor with a catalyst, a complex oxide of the formula CuₓCe₁₋ₓO_{2-y}. From the reactive gaseous mixture the CO is removed by oxidation with the stoichiometric amount of oxygen added to the CO₂, while the parallel reaction of oxidation of excess hydrogen does not occur. The selective CO oxidation runs at the temperature that is below the flight-off temperature for the hydrogen oxidation reaction on this catalyst. The reaction runs at temperature between 323 K and 473 K, at a pressure between 1 and 10 bar, and at the ratio of partial pressures of oxygen and carbon monoxide λ=2p₀₂/P_{co} between 1.0 and 2.5.

Among the gaseous streams containing excess hydrogen, in which the carbon monoxide is selectively oxidised with the catalyst, a complex oxide of the formula CuₓCe₁₋ₓO_{2-y}, belong the products of partial oxidation, steam reforming, and autothermal reforming of gasoline oil fractions, of lower hydrocarbons, of natural gas, of methanol and of other lower alcohols. These gaseous mixtures contain between 0.1 and 10 vol. % of CO, between 10 and 30 vol. % CO₂, between 40 and 70 vol. % H₂, between 0 and 5 vol. % H₂O and under 1 vol. % of unreacted fuel. Carbon dioxide, which is strongly co-adsorbed on the surface of the catalyst usually, retards the oxidation of carbon monoxide.

In the following are given several working Examples for the preparation of the present catalyst, namely the complex oxide kCuₓCe₁₋ₓO_{2-y}, further working Examples for the catalytic oxidation of carbon monoxide, the catalytic oxidation of carbon monoxide in the presence of excess CO₂, the catalytic, selective oxidation of carbon monoxide in a gaseous mixture with excess hydrogen, and the catalytic, selective oxidation of carbon monoxide in a gaseous mixture with excess hydrogen and excess CO₂.

This invention is illustrated by the Examples, but in no way limited in its scope by the mentioned Examples.

In determining the properties of synthesized and heat-treated samples of the catalysts enumerated in the Examples the following methods were used:

X-ray powder diffractograms of the samples were obtained on the Philips PW 1710 apparatus with automatic divergence slit, graphite monochromator, and CuK_{α} (λ=0.15407 nm) beam source in the interval of angles 2Θ between 6 and 70° with a scanning rate of 1° min⁻¹;

The specific surface was determined with one-point BET method in a dynamic flow apparatus Flowsorb II 2300 (Micromeritics Instrument Corp., Norcross, Ga.);

The reactions of oxidation and of selective oxidation of carbon monoxide were performed in a quartz tubular reactor with dimensions 6 mm o.d.×4 mm i.d.×310 mm length. An enlargement of 8 mm at the central part of the tube contained a bung of quartz wool with a thin bed with 0.050 g of the catalyst in the form of grains of the size (fraction) between 0.09 and 0.16 mm. The reactor worked in a differential mode at a temperature between 298 K and 573 K and at flow rate of the gaseous mixture between 50 and 100 cm³·min ⁻¹. For the two reactions were used synthetic gaseous mixtures containing:

1 vol. % CO+0.5 vol. % O₂+He;

1 vol. % CO+0.5 vol. % O₂+15 vol. % CO₂+He;

1 vol. % CO+1.25 vol. % O₂₊₅₀ vol. % H₂+He;

1 vol. % CO+1.25 vol. % O₂+50 vol. % H₂+15 vol. % CO₂+He.

In this manner we tested also the influence of the presence of CO₂ on the reaction rate and selectivity in both reactions. The reaction products were analysed with a gas chromatograph having a thermal conductivity detector (TCD) on a suitable chromatographic column. The conversions of carbon monoxide and oxygen were determined from the difference between their inlet and outlet concentrations, respectively. The selectivity was calculated from the mass balance of oxygen:

$$S = \frac{0.5 \times {C}_{CO2}^{out}}{{C}_{O2}^{i n} - {C}_{O2}^{out}} ,$$

where S is selectivity, C₀₂ⁱⁿ is the inlet concentration of oxygen, C₀₂^{out} and C_{C02}^{out} are the outlet concentrations of oxygen and carbon dioxide.

### EXAMPLE 1 (SYNTHESIS)

To 10 mL of 0.225 mol·L⁻¹ of Cu(NO₃)₂ in a 250 mL glass beaker was admixed 90 mL of 0.150 mol·L⁻¹ Ce(NO₃)₃. During the stirring of the solution with a magnetic stirrer at 60 rpm was added dropwise 20 mL of a 11% solution of Na₂CO₃ at a rate of 1.5 mL·min⁻¹, so that the pH of the solution was kept below 6.0. The solution was homogenized by stirring for for another 60 minutes. The resulting suspension was filtered through the filter paper of “Blue ribbon” quality, and the obtained precipitate was washed on the filter with a three-fold volume of boiling demineralised water. The precipitate was then dried for 12 hours at 383 K. The dried product was heat-treated in shallow bed and in the flow of dry air for 1 hour at 1133 K. The cooled product in the form of a powder was the catalyst Cu_{0.143}Ce_{0.857}O_{1.857-y}.

### EXAMPLE 2 (SYNTHESIS)

To 10 mL of 0.225 mol·L⁻¹ of Cu(NO₃)₂ in a 250 mL glass beaker was admixed 90 mL of 0.150 mol·L⁻¹ Ce(NO₃)₃. During the stirring of the solution with a magnetic stirrer at 400 rpm was added dropwise 20 mL of the 11% solution of Na₂CO₃ at a rate of 1.5 mL·min⁻¹, so that the pH of the solution was kept below 6.0. The solution was homogenized by stirring for another 60 minutes. The resulting suspension was then filtered through the filter paper of “Blue ribbon” quality. The obtained precipitate was washed with a three-fold volume of boiling demineralized water. The precipitate is then dried for 12 hours at 383 K. The dried product was heat-treated in shallow bed and in the flow of dry air for 1 hour at a temperature of 1133 K. The cooled product in the form of a powder was the catalyst Cu_{0.143}Ce_{0.857}O_{1.857-y}.

### EXAMPLE 3 (SYNTHESIS)

To 10 mL of 0.225 mol·L⁻¹ of Cu(NO₃)₂ in a 250 mL glass beaker was admixed 90 mL of 0.150 mol·L⁻¹ Ce(NO₃)₃. During the stirring with a magnetic stirrer at 740 rpm was added dropwise 20 mL of the 11% solution of Na₂CO₃ at a rate of 1.5 mL·min⁻¹, so that the pH of the solution was kept below 6.0. The suspension was then homogenized by stirring for another 60 minutes. The resulting suspension was then filtered through the filter paper of “Blue ribbon” quality, and the precipitate was washed on the filter with a three-fold volume of boiling demineralized water. The precipitate is then dried for 12 hours at 383 K. The dried product was subsequently heat-treated in shallow bed and in the flow of dry air for 1 hour at a temperature of 1133 K.

The cooled product in the form of a powder was the catalyst Cu_{0.143}Ce_{0.857}O_{1.857-y}.

### EXAMPLE 4 (SYNTHESIS)

To 25 mL of 0.15 mol·L⁻¹ of Cu(NO₃)₂ in a 1000 mL plastic beaker was admixed 475 mL of 0.10 mol·L⁻¹ Ce(NO₃)₃. During the stirring with a turbine stirrer (Ultra Turrax T50, Janke und Kunkel) at 4000 rpm was added dropwise 100 mL of the 7% solution of Na₂CO₃ at a rate of 1.5 mL·min⁻¹, so that the pH of the solution was kept below 6.0. The solution was then homogenized by stirring for another 30 minutes. The resulting suspension was filtered through the filter paper of “Blue ribbon” quality, and the obtained precipitate was washed with a three-fold volume of boiling demineralized water. The precipitate was dried for 12 hours at 383 K. The dried product was heat-treated in shallow bed and in the flow of dry air for 1 hour at a temperature of 1133 K. The cooled product in the form of a powder was the catalyst Cu_{0.073}Ce_{0.927}O_{1.927-y}.

### EXAMPLE 5 (SYNTHESIS)

To 50 mL of 0.15 mol·L⁻¹ of Cu(NO₃)₂ in a 1000 mL plastic beaker was admixed 450 mL of 0.10 mol·L⁻¹ Ce(NO₃)₃. During the stirring with a turbine stirrer (Ultra Turrax T50, Janke und Kunkel) at 4000 rpm was added dropwise to this solution 100 mL of the 7% solution of Na₂CO₃ at a rate of 1.5 mL·min⁻¹, so that the pH of the solution was kept below 6.0. The solution was then homogenized by stirring for another 30 minutes. The resulting suspension was then filtered through the filter paper of “Blue ribbon” quality, and the obtained precipitate was washed with a three-fold volume of boiling demineralized water. The precipitate was dried for 12 hours at 383 K. The dried product was heat-treated in shallow bed and in the flow of dry air for 1 hour at a temperature of 1133 K. The cooled product in the form of a powder was the catalyst Cu_{0.143}Ce_{0.857}O_{1.857-y}.

### EXAMPLE 6 (SYNTHESIS)

To 50 mL of 0.15 mol·L⁻¹ of Cu(NO₃)₂ in a 1000 mL plastic beaker was admixed 450 mL of 0.10 mol·L⁻¹ Ce(NO₃)₃. During the stirring of the solution with a turbine stirrer (Ultra Turrax T50, Janke und Kunkel) at 4000 rpm was added dropwise to this solution 100 mL of the 7% of Na₂CO₃ at a rate of 1.5 mL·min⁻¹, so that the pH of the solution was kept below 6.0. The solution was then homogenized by stirring for further 30 minutes. The resulting suspension was then filtered through the filter paper of “Blue ribbon” quality, and the obtained precipitate was washed on the filter with a three-fold volume of boiling demineralized water. The precipitate was dried for 12 hours at 383 K. The dried product was heat-treated in shallow bed and in the flow of dry air for 1 hour at 773 K. The cooled product in the form of a powder was the catalyst Cu_{0.143}Ce_{0.857}O_{1.857-y}.

### EXAMPLE 7 (SYNTHESIS)

To 75 mL of 0.15 mol·L⁻¹ of Cu(NO₃)₂ in a 1000 mL plastic beaker was admixed 425 mL of 0.10 mol·L⁻¹ Ce(NO₃)₃. During the stirring with a turbine stirrer (Ultra Turrax T50, Janke und Kunkel) at 4000 rpm was added dropwise to this solution 100 mL of the 7% solution of Na₂CO₃ at a rate of 1.5 mL·min⁻¹, so that the pH of the mixed solution was kept below 6.0. The solution was then homogenized by stirring for another 30 minutes. The resulting suspension was filtered through the filter paper of “Blue ribbon” quality, and the precipitate was washed on the filter with a three-fold volume of boiling demineralized water. The precipitate was dried for 12 hours at 383 K. The dried product was heat-treated in shallow bed and in the flow of dry air for 1 hour at 1133 K. The cooled product in the form of a powder was the catalyst Cu_{0.209}Ce_{0.791}O_{1.791-y}.

### EXAMPLE 8 (SYNTHESIS)

To 100 mL of 0.15 mol·L⁻¹ of Cu(NO₃)₂ in a 1000 mL plastic beaker was admixed 400 mL of 0.10 mol·L⁻¹ Ce(NO₃)₃. During the stirring with a turbine stirrer (Ultra Turrax T50, Janke und Kunkel) at 4000 rpm was added dropwise to this solution 100 mL of the 7% solution of Na₂CO₃ at a rate of 1.5 mL·min⁻¹, so that the pH of the solution was kept below 6.0. The solution was then homogenized by stirring for another 30 minutes. The resulting suspension was filtered through the filter paper of “Blue ribbon” quality, and the obtained precipitate was washed on a filter with a three-fold volume of boiling demineralized water. The precipitate was dried for 12 hours at 383 K. The dried product was subsequently heat-treated in shallow bed and in the flow of dry air for 1 hour at 773 K. The cooled product in the form of a powder was the catalyst Cu_{0.273}Ce_{0.727}O_{1.727-y}.

### EXAMPLE 9 (SYNTHESIS)

To 10 mL of 0.225 mol·L⁻¹ of Cu(NO₃)₂ in a 250 mL glass beaker was admixed 90 mL of 0.150 mol·L⁻¹ Ce(NO₃)₃. During the stirring with a magnetic stirrer at a rate of 60 rpm was added dropwise 20 mL of the 11% solution of Na₂CO₃ at a rate of 0.1 mL·min⁻¹, so that the pH of the solution was kept below 6.0. The solution was then homogenized for another 60 minutes. The resulting suspension was filtered through the filter paper of “Blue ribbon” quality, and the precipitate was washed on a filter with a three-fold volume of boiling demineralized water. The precipitate was then dried for 12 hours at 383 K. The dried product was heat-treated in shallow bed and in the flow of dry air for 1 hour at 1133 K. The cooled product in the form of a powder was the catalyst Cu_{0.143}Ce_{0.857}O_{1.857-y}.

### EXAMPLE 10 (SYNTHESIS)

To 10 mL of 0.225 mol·L⁻¹ of Cu(NO₃)₂ in a 250 mL glass beaker was admixed 90 mL of 0.150 mol·L⁻¹ Ce(NO₃)₃. During the stirring with a magnetic stirrer at a rate of 400 rpm was aadded dropwise to this solution 20 mL of the 11% solution of Na₂CO₃ at a rate of 3.0 mL·min⁻¹, so that the pH of the solution was kept below 6.0. The solution was then homogenized by stirring for another 60 minutes. The suspension was filtered through the filter paper of “Blue ribbon” quality, and the precipitate was Washed on a filter with a three-fold volume of boiling demineralized water. The precipitate was dried for 12 hours at 383 K. The dried product was heat-treated in shallow bed and in the flow of dry air for 1 hour at 1133 K. The cooled product in the form of a powder was the catalyst Cu_{0.143}Ce_{0.857}O_{1.857-y}.

### EXAMPLE 11 (SYNTHESIS)

To 10 mL of 0.015 mol·L⁻¹ of Cu(NO₃)₂ in a 250 mL glass beaker was admixed 90 mL of 0.01 mol·L⁻¹ Ce(NO₃)₃. During the stirring with a magnetic stirrer at 400 rpm was added dropwise to tis solution 20 mL of the 11% water solution of Na₂CO₃ at a rate of 1.5 mL·min⁻¹, so that the pH of the solution was kept below 6.0. The solution was-then homogenized by stirring for another 60 minutes. The resulting suspension was then filtered through the filter paper of “Blue ribbon” quality, and the precipitate was washed with a three-fold volume of boiling demineralized water. The precipitate was dried for 12 hours at 383 K. The dried product was heat-treated in shallow bed and in the flow of dry air for 1 hour at 1133 K. The cooled product in the form of a powder was the catalyst Cu_{0.143}Ce_{0.857}O_{1.857-y}.

### EXAMPLE 12 (SYNTHESIS)

To 10 mL of 0.435 mol·L⁻¹ of Cu(NO₃)₂ in a 250 mL glass beaker was admixed 90 mL of 0.290 mol·L⁻¹ Ce(NO₃)₃. During the stirring with a magnetic stirrer at 400 rpm was added dropwise to this solution 20 mL of the 11% solution of Na₂CO₃ at a rate of 1.5 mL·min⁻¹, so that the pH of the solution was kept below 6.0. The solution was then homogenized by stirring for another 60 minutes. The resulting suspension was then filtered through the filter paper of “Blue ribbon” quality, and the precipitate was washed with a three-fold volume of boiling demineralized water. The precipitate was then dried for 12 hours at 383 K. The dried product was heat-treated in shallow bed and in the flow of dry air for 1 hour at 1133 K. The cooled product in the form of a powder was the catalyst Cu_{0.143}Ce_{0.857}O_{1.857-y}.

### EXAMPLE 13 (SYNTHESIS)

To 50 mL of 0.15 mol·L⁻¹ of Cu(NO₃)₂ in a 1000 mL plastic beaker was admixed 450 mL of 0.10 mol·L⁻¹ Ce(NO₃)₃. During stirring with a turbine stirrer at 4000 rpm was added to this solution 100 mL of the 7% solution of (NH₄)₂C₂O₄ at a rate of 1.5 mL·min⁻¹, so that the pH of the solution was kept below 6.0. The solution was then homogenized by stirring for another 30 minutes. The resulting suspension was then filtered through the filter paper of “Blue ribbon” quality, and the obtained coprecipitate was washed with a three-fold volume of boiling demineralized water. The precipitate was then dried for 12 hours at 383 K. The dried product was heat-treated in shallow bed and in the flow of dry air for 1 hour at 773 K. The cooled product in the form of a powder was the catalyst Cu_{0.143}Ce_{0.857}O_{1.857-y}.

### EXAMPLE 14 (SYNTHESIS)

To 10 mL of 0.225 mol·L⁻¹ of Cu(NO₃)₂ in a 250 mL glass beaker was admixed 90 mL of 0.150 mol·L⁻¹ Ce(NO₃)₃. During stirring with a magnetic stirrer at 740 rpm was added dropwise to this solution 20 mL of the 11% solution of Na₂CO₃ at a rate of 1.5 mL·min⁻¹, so that the pH of the solution was kept below 6.0. The solution was then homogenized by stirring for another 60 minutes. The resulting suspension was filtered through the filter paper of “Blue ribbon” quality, and the precipitate was washed with a three-fold volume of boiling demineralized water. The precipitate was dried for 12 hours at 383 K. The dried product was heat-treated in shallow bed and in the flow of dry air for 1 hour at 933 K. The cooled product in the form of a powder was the catalyst Cu_{0.143}Ce_{0.857}O_{1.857-y}.

### EXAMPLE 15 (SYNTHESIS)

To 100 mL of 0.15 mol·L⁻¹ of Cu(NO₃)₂ in a 1000 mL plastic beaker was admixed 400 mL of 0.10 mol·L⁻¹ Ce(NO₃)₃. During the stirring with a turbine stirrer (Ultra Turrax T50, Janke und Kunkel) at 4000 rpm was added dropwise to this solution 100 mL of the 7% solution of Na₂CO₃ at a rate of 1.5 mL·min⁻¹, so that the pH of the solution-was kept below 6.0. The solution was then homogenized by stirring for another 30 minutes. The resulting suspension was filtered through the filter paper of “Blue ribbon” quality, and the precipitate was washed on a filter with a three-fold volume of boiling demineralized water. The precipitate was dried for 12 hours at 383 K. The dried product was heat-treated in shallow bed and in the flow of dry air for 1 hour at 933 K. The cooled product in the form of a powder was the catalyst Cu_{0.273}Ce_{0.727}O_{1.727-y}.

### EXAMPLE 1 FOR THE CO OXIDATION

This example includes the use of catalysts prepared in accordance with the processes as described in synthesis Examples 4, 5 and 7.

A bed with 50 mg of catalyst sample in the form of grains with fraction between 0.09 and 0.16 mm diluted with 300 mg of quartz grains of the same fraction was immobilised between two bungs of quartz wool in the differential quartz tubular reactor having an inner diameter of 8 mm and the length of 310 mm. On one side the reactor was connected to the gas mixing battery connected to and mass-flow controllers for each gaseous reactant. The thermocouple, isolated in quartz tube, was inserted into the middle of the catalyst bed. On the outlet side the tubular reactor was connected through the dosing loop to the gas chromatograph with thermal conductivity detector (TCD) in order to analyse the reaction products.

The fresh sample of the catalyst was calcined for 2 hours at 673 K in a flow of the oxidizing gaseous mixture (20 vol. % O₂+He). Before each catalytic experiment the catalyst sample was calcined for 30 minutes at 673 K in an oxidizing gaseous mixture of the same composition in order to clean the surface of the catalyst, followed by cooling down the catalyst sample to the reaction temperature in a flow of pure He. When the temperature in the reactor was stabilized, the reactor was switched on the gaseous reaction mixture containing 1 vol. % CO+0.5 vol. % O₂+He, and the flow rate of 100 cm³·min⁻¹ was adjusted. The reaction products were analysed at the exit of the reactor with a gas chromatograph.

In Table 1 are given the results of the CO conversion as function of the reaction temperature of the mentioned catalysts.

TABLE 1
CO conversion as a function of reaction temperature

| | CO conversion for catalysts | | |
|---|---|---|---|
| | synthesised in: | | |
| Temp. (K) | Example 4 | Example 5 | Example 7 |
| 323 | 0 | 0.04 | 0.02 |
| 348 | 0.04 | 0.16 | 0.09 |
| 373 | 0.19 | 0.57 | 0.40 |
| 393 | 0.40 | 0.76 | 0.56 |
| 413 | 0.52 | 0.85 | 0.73 |
| 433 | 0.63 | 0.94 | 0.89 |
| 453 | 0.71 | 0.98 | 0.96 |
| 473 | | 0.99 | 0.99 |
| 483 | 0.81 | | |
| 493 | | 1.00 | 1.00 |
| 513 | 0.88 | | |
| 543 | 0.92 | | |
| 573 | 0.95 | | |

In Table 2 are given the CO oxidation reaction rates at a temperature of 348 K.

TABLE 2
Reaction rates for the CO oxidation at 348 K

| | Example 4 | Example 5 | Example 7 |
|---|---|---|---|
| Mol. CuO | 0.073 | 0.143 | 0.209 |
| r_{co} × 10⁷ [mol · (s · g_{cat})⁻¹] | 6.61 | 22.57 | 13.71 |
| r_{co} × 10⁴ [mol · (s · mol_{Cu})⁻¹] | 5.75 | 10.03 | 4.17 |

### EXAMPLE 2 FOR THE CO OXIDATION

This example includes the use of catalysts prepared in accordance the processes as described in the synthesis Examples 4, 5 and 7.

A bed with 50 mg of a catalyst sample in the form of grains with fraction between 0.09 and 0.16 mm diluted with 300 mg of quartz grains of the same fraction was immobilised between two bungs of quartz wool in the differential quartz tubular reactor having an inner diameter of 8 mm and the length of 310 mm. On one side the reactor was connected to the gas mixing battery connected with mass-flow controllers for each gaseous reactant. The thermocouple, isolated in quartz tube, was inserted into the middle of the catalyst bed. On the outlet side the tubular reactor was connected through the dosing loop to the gas chromatograph with thermal conductivity detector (TCD) in order to analyse the reaction products.

The fresh sample of the synthesized catalyst was calcined for 2 hours at 673 K in a flow of an oxidizing gaseous mixture (20 vol. % O₂+He). Before each catalytical experiment the catalyst sample was calcined for 30 minutes at 673 K in a flow of an oxidizing gaseous mixture of the same composition in order to clean the catalyst surface, followed by cooling down the catalyst sample to the reaction temperature in a flow of pure He. When the temperature in the reactor was stabilised, the reactor was switched on the gaseous reaction mixture containing 1 vol. % CO+0.5 vol. % O₂+15 vol. % CO₂+He and the flow rate of 100 cm³·min⁻¹ was adjusted. The reaction products were analysed at the exit of the reactor with a gas chromatograph.

In Table 3 are given CO conversions as a function of the reaction temperature for the mentioned catalysts.

TABLE 3
CO conversion as a function of reaction temperature in
the presence of 15 vol. % CO₂ in
the reaction mixture.

| | CO conversion for catalysts | | |
|---|---|---|---|
| | synthesized in: | | |
| Temp. (K) | Example 4 | Example 5 | Example 7 |
| 303 | | | |
| 323 | | | |
| 348 | | 0.03 | |
| 373 | 0.04 | 0.17 | 0.10 |
| 393 | 0.15 | 0.46 | 0.34 |
| 413 | 0.40 | 0.75 | 0.64 |
| 433 | 0.55 | 0.86 | 0.77 |
| 453 | 0.64 | 0.91 | 0.88 |
| 473 | 0.70 | 0.95 | 0.94 |
| 483 | 0.74 | | |
| 493 | | | 0.97 |
| 513 | 0.81 | 0.98 | 0.99 |
| 543 | 0.86 | 1.00 | 1.00 |
| 573 | 0.90 | | |

In Table 4 are given the CO oxidation reaction rates at a temperature of 348 K in the presence of 15 vol. % CO₂ in the reaction mixture.

TABLE 4
Reaction rates of CO oxidation at 348 K in the
presence of 15 vol. % CO₂ in the reaction stream

| | Example 4 | Example 5 | Example 7 |
|---|---|---|---|
| Mol. CuO | 0.073 | 0.143 | 0.209 |
| r_{co} × 10⁷ [mol · (s · g_{cat})⁻¹] | 0.744 | 3.733 | 1.19 |
| r_{co} × 10⁴ [mol · (s · mol_{Cu})⁻¹] | 0.65 | 1.66 | 0.36 |

### EXAMPLE 3 FOR THE SELECTIVE CO OXIDATION

This example includes the use of catalysts prepared in accordance with the processes as described in Examples 4, 5 and 7.

A bed with 50 mg of a catalyst sample in the form of grains with fraction between 0.09 and 0.16 mm diluted with 300 mg of quartz grains of the same fraction was immobilised between two bungs of quartz wool in the differential quartz tubular reactor having an inner diameter of 8 mm and the length of 310 mm. On one side the reactor was connected to the gas mixing battery connected with mass-flow controllers for each gaseous reactant. The thermocouple isolated in quartz tube, was inserted into the middle of the catalyst bed. On the outlet side the tubular reactor was connected through the dosing loop to the gas chromatograph with the thermal conductivity detector (TDC) in order to analyse the reaction products.

A fresh sample of the synthesized active substance was calcined for 2 hours at 673 K in a flow of the oxidizing gaseous mixture (20 vol. % O₂+He). Before each catalytic experiment the catalyst sample was calcined for 30 minutes at 673 K in an oxidizing gaseous mixture of the same composition in order to clean the catalyst surface, followed by cooling down the catalyst sample to the desired reaction temperature in a flow of pure He. When the temperature in the reactor was stabilized, the reactor was switched on the gaseous reaction mixture containing 1 vol. % CO+1.25 vol. % O₂+50 vol. % H₂+He and the flow rate of 100 cm³·min⁻¹wa adjusted. The reaction products were analysed at the exit from the reactor with a gas chromatograph.

In Table 5 are given the results of CO and O₂ conversions and the selectivity for CO oxidation in function of the reaction temperature for the mentioned catalysts.

TABLE 5
CO conversion, O₂ conversion and selectivity of
CO oxidation as a function of reaction temperature

| | Catalysts synthesised in: | | | | | | | | |
|---|---|---|---|---|---|---|---|---|---|
| Temp. | Example 4 | | | Example 5 | | | Example 7 | | |
| (K) | χco | χo2 | S_{co} | χco | χo2 | S_{co} | χco | χo2 | S_{co} |
| 303 | 0 | 0 | — | | | | | | — |
| 323 | | | — | 0.02 | 0.008 | 1.00 | | | — |
| 348 | 0.07 | 0.03 | 0.93 | 0.15 | 0.06 | 1.00 | 0.11 | 0.05 | 0.99 |
| 373 | 0.24 | 0.10 | 0.93 | 0.51 | 0.204 | 1.00 | 0.41 | 0.17 | 0.99 |
| 393 | 0.44 | 0.19 | 0.93 | 0.69 | 0.28 | 1.00 | 0.55 | 0.23 | 0.98 |
| 413 | 0.60 | 0.27 | 0.91 | 0.81 | 0.34 | 0.99 | 0.65 | 0.28 | 0.95 |
| 433 | 0.73 | 0.34 | 0.87 | 0.87 | 0.40 | 0.92 | 0.74 | 0.34 | 0.89 |
| 453 | 0.82 | 0.42 | 0.79 | 0.92 | 0.48 | 0.79 | 0.81 | 0.42 | 0.78 |
| 473 | 0.89 | 0.53 | 0.68 | 0.95 | 0.66 | 0.60 | 0.86 | 0.55 | 0.63 |
| 493 | 0.91 | 0.69 | 0.53 | 0.92 | 0.92 | 0.41 | 0.89 | 0.83 | 0.44 |
| 513 | 0.90 | 0.92 | 0.39 | 0.84 | 1.00 | 0.35 | 0.68 | 0.99 | 0.28 |
| 533 | 0.71 | 1.00 | 0.29 | | | | | | |

In Table 6 are given the CO oxidation reaction rates for the selective CO oxidation at a temperature of 348 K.

TABLE 6
Reaction rates of selective CO oxidation at 348 K

| | Example 4 | Example 5 | Example 7 |
|---|---|---|---|
| Mol. CuO | 0.073 | 0.143 | 0.209 |
| r_{co} × 10⁷ [mol · (s · g_{cat})⁻¹] | 8.937 | 22.77 | 16.17 |
| r_{co} × 10⁴ [mol · (s · mol_{Cu})⁻¹] | 7.78 | 10.12 | 4.92 |

### EXAMPLE 4 FOR THE SELECTIVE CO OXIDATION

This example includes the use of catalysts prepared in accordance with the processes as described in synthesis Examples 4, 5 and 7.

A bed with 50 mg of catalyst sample in the form of grains with fraction between 0.09 and 0.16 mm diluted with 300 mg of quartz grains of the same fraction was immobilised between two bungs of quartz wool in the differential quartz tubular reactor having an inner diameter of 8 mm and the length of 310 mm. On one side the reactor was connected to the gas mixing battery connected with mass-flow controllers for each gaseous reactant. The thermocouple isolated in quartz tube, was inserted into the middle of the catalyst bed. On the outlet side the reactor was connected through the dosing loop to the gas chromatograph with thermal conductivity detector (TCD) in order to analyse the reaction products.

The fresh sample of the synthesized active substance was calcined for 2 hours at 673 K in a flow of the oxidizing gaseous mixture (20 vol. % O₂+He). Before each catalytic experiment the catalyst sample was calcined for 30 minutes at 673 K in an oxidizing gaseous mixture having the same composition, in order to clean the catalyst surface, followed by cooling down the catalyst sample to the desired reaction temperature in a flow of pure He. When the temperature in the reactor was stabilised, the reactor was switched on the reaction gaseous mixture containing 1 vol. % CO+1.25 vol. % O₂+50 vol. % H₂+15 vol. % CO₂+He and the flow rate of 100 cm³·min⁻¹ was adjusted. The reaction products were analysed at the exit of the reactor with a gas chromatograph.

In Table 7 are given the CO and O₂ conversions and the selectivity for the CO oxidation as function of the reaction temperature the mentioned catalysts.

TABLE 7
CO conversion, O₂ conversion and selectivity of
the CO oxidation in the presence of CO₂ in
gaseous mixture as a function of reaction

| | Catalysts synthesized in: | | | | | | | | |
|---|---|---|---|---|---|---|---|---|---|
| Temp. | Example 4 | | | Example 5 | | | Example 7 | | |
| (K) | χco | χo2 | S_{co} | χco | χo2 | S_{co} | χco | χo2 | S_{co} |
| 303 | | | — | | | — | | | — |
| 323 | | | — | 0 | 0 | — | | | — |
| 348 | 0 | 0 | — | 0.02 | 0.01 | 1.00 | 0 | 0 | — |
| 373 | 0.06 | 0.02 | 1.00 | 0.14 | 0.05 | 1.00 | 0.09 | 0.04 | 0.94 |
| 393 | 0.18 | 0.07 | 1.00 | 0.36 | 0.14 | 1.00 | 0.24 | 0.11 | 0.89 |
| 413 | 0.42 | 0.17 | 1.00 | 0.62 | 0.25 | 1.00 | 0.49 | 0.22 | 0.92 |
| 433 | 0.63 | 0.28 | 0:97 | 0.78 | 0.35 | 0.93 | 0.66 | 0.30 | 0.90 |
| 453 | 0.77 | 0.38 | 0.86 | 0.86 | 0.43 | 0.82 | 0.74 | 0.38 | 0.80 |
| 473 | 0.85 | 0.52 | 0.69 | 0.90 | 0.56 | 0.67 | 0.80 | 0.52 | 0.63 |
| 493 | 0.88 | 0.83 | 0.45 | 0.91 | 0.94 | 0.40 | 0.78 | 0.94 | 0.34 |
| 513 | 0.83 | 0.99 | 0.35 | 0.80 | 1.00 | 0.33 | 0.69 | 1.00 | 0.28 |
| 533 | 0.72 | 1.00 | 0.30 | | | | | | |

In Table 8 are given the reaction rates for the selective CO oxidation at a temperature of 348 K in the presence of CO₂ in the gaseous mixture.

TABLE 8
Reaction rates of selective CO oxidation at 348 K
in the presence of CO₂ in the gaseous mixture

| | Catalysts synthesised in: | | |
|---|---|---|---|
| | Example 4 | Example 5 | Example 7 |
| Mol. CuO | 0.073 | 0.143 | 0.209 |
| r_{co} × 10⁷ [mol · (s · g_{cat})⁻¹] | 1.636 | 3.019 | <0.1 |
| r_{co} × 10⁴ [mol · (s · mol_{Cu})⁻] | 1.42 | 1.34 | <0.030 |

### EXAMPLE 5 FOR THE SELECTIVE CO OXIDATION

This example includes the use of catalyst prepared in accordance with the process as described in the synthesis Example 5.

A bed with 50 mg of catalyst sample in the form of grains with fraction between 0.09 and 0.16 mm diluted with 300 mg of quartz grains of the same fraction was immobilised between two bungs of quartz wool in the differential quartz tubular reactor having an inner diameter of 8 mm and the length of 310 mm. On one side the reactor was connected to the gas mixing battery connected to mass-flow controllers for each gaseous reactant. The thermocouple isolated in quartz tube, was inserted into the middle of the catalyst bed. On the outlet side the reactor was connected through the dosing loop to the gas chromatograph with a thermal conductivity detector (TCD) in order to analyse the reaction products.

The fresh sample of the synthesized active substance was calcined for 2 hours at 673 K in a flow of the oxidizing gaseous mixture (20 vol. % O₂+He). Before each catalytical experiment the catalyst sample was calcined for 30 min at 673 K in an oxidizing gaseous mixture of the same composition in order to clean the catalyst surface, followed by cooling down the catalyst sample to the desired reaction temperature in a flow of pure He. When the temperature in the reactor was stabilised, the reactor was switched on the reaction gaseous mixture containing 1 vol. % CO+0.5 vol. % O₂+50 vol. % H₂+He and the flow rate of 100 cm³·min⁻¹ was adjusted. The reaction products were analysed at the exit of the reactor with a gas chromatograph.

In table 9 are given the CO and O₂ conversions and the selectivity for the CO oxidation as function of the reaction temperature and the contact time for the mentioned catalyst.

TABLE 9
CO conversion (χco), O₂ conversion (χo2)
and selectivity (S) as a function of the reaction temperature
and the contact time (W/F)* on the catalyst obtained by
the process in the synthesis Example 5.

| | | |
|---|---|---|
| | W/F = | W/F = |
| Temp. | 0.09 g · s · cm⁻³ | 0.36 g · s · cm⁻³ |

| (K) | χco | χo2 | S | χco | χo2 | S |
|---|---|---|---|---|---|---|
| 303 | 0 | 0 | — | 0.11 | 0.10 | 1.00 |
| 323 | 0.04 | 0.06 | 1.00 | 0.19 | 0.20 | 1.00 |
| 343 | | | | 0.59 | 0.58 | 1.00 |
| 348 | 0.25 | 0.26 | 1.00 | | | |
| 353 | | | | 0.78 | 0.75 | 1.00 |
| 363 | | | | 0.83 | 0.80 | 1.00 |
| 373 | 0.63 | 0.64 | 1.00 | 0.92 | 0.90 | 0.99 |
| 383 | | | | 0.97 | 0.98 | 0.96 |
| 393 | 0.80 | 0.84 | 0.96 | 0.95 | 1.00 | 0.93 |
| 403 | 0.84 | 0.90 | 0.94 | — | — | — |
| 413 | 0.85 | 0.96 | 0.89 | — | — | — |
| 433 | 0.80 | 1.00 | 0.81 | | | |

*W-catalyst loading in g; F-flow rate of the reactant mixture in cm³ · s⁻¹

1. A process for catalytic, selective oxidation of carbon monoxide in gaseous mixtures containing excess hydrogen, characterized in that gaseous mixtures comprising 0.1 to 10 vol. % CO, 10 to 30 vol. % CO₂, 40 to 70 vol. % H₂, 0 to 5 vol. % H₂O and less than 1 vol. % of unreacted fuel, are oxidized with the stoichiometric quantity of oxygen at temperatures between 298 and 573 K, pressures between 1 and 10 bar and the ratio of the partial pressures of oxygen and carbon monoxide (λ=2P₀₂/P_{co}) between 1.0 and 2.5 in a one-step flow reactor with contact times (W/F) between 0.03 and 0.40 g·s·cm⁻³ or at the flow rate (F) of the gaseous mixture between 0.083 cm³s⁻¹ and 1.67 cm³s⁻¹ in the presence of 0.010 to 0.100 g of the catalyst (W):
a complex oxide of the formula CuₓCe₁₋ₓO_{2-y} wherein x is between 0.01 and 0.30, while y is equal or greater than x, in which the constituent oxide phases that can be qualitatively determined by X-ray powder diffraction have the following unit cell parameters:
CeO₂ (cerianite): cubic Fm3m; a=0.541134 nm; st.dev.=±0.00012;
Cu₂O (cuprite): cubic Pn3m; a=0.42696 nm;
CuO (tenorite): monoclinic C₂/c; a=0.4685 nm;
b=0.3423 nm;
c=0.5132 nm;
β=99.52°.

2. A process for the preparation of the complex oxide according to claim 1, characterized by:
a) co-precipitation of copper and cerium ions from the aqueous solution having a concentration of 0.03 to 0.9 F of well dissociated copper and cerium salts, wherein the volume ratio of aqueous solutions of copper and cerium salt salts of equal formality is between 1:99 and 25:75, by the addition of a strong alkaline precipitant in acidic medium, at the volume ratio of the mixture of the Cu and Ce ions and the precipitant solution between 10:1 and 5:1, while stirring at 60 to 4000 rpm during the time period of 30 to 90 minutes;
b) filtering the obtained co-precipitation product, washing the filtered precipitate with hot demineralized water and drying it into a powder;
c) optionally, shaping the obtained powder by the addition of conventional binders into conventional catalyst forms;
d) heat-treating the obtained powder or forms in a shallow bed under the flow of dry air at for 15 to 300 minutes at a temperature between 773 K and 1133 K.

3. A process acccording to claim 2, characterized by using as the cerium salt the cerium (III) nitrate, cerium (III) chloride, cerium (III) sulphate.

4. A process according to claim 2, characterized by using as the copper salt the copper (II) nitrate, copper (II) chloride, copper (II) sulphate.

5. A process according to claim 2, characterized by using as the alkaline precipitant a water soluble salt of a strong base with a weak acid.

6. A process according to claim 5, characterized by using as the salt the sodium carbonate or ammonium oxalate.

7. A catalyst for use in the process of catalytic, selective oxidation of carbon monoxide in gaseous mixtures containing excess hydrogen, characterized by being obtained according to claims 2 to 6.
